(19) United States
(12) Patent Application Publication
(10) Pub. No.: US 2011/0255269 A1
(43) Pub. Date: Oct. 20, 2011

(54) PET SHOE

(76) Inventor: Chung Te Liao, Taipei City (TW)

(21) Appl. No.: 12/759,716

(22) Filed: Apr. 14, 2010

(51) Int. Cl. F21V 21/08

(52) U.S. Cl. 362/103

(57) ABSTRACT

A pet shoe features for a warning device on a shoe body thereof. When a pet wearing the pet shoe is moving, a vibration switch in the warning device senses movements and accordingly drives a light-emitting element to blink so as to provide warning.

### BACKGROUND OF THE INVENTION

1. Technical Field

The present invention relates to pet shoes, and particularly to a pet shoe that emits light.

2. Description of Related Art

It has been a trend that modern people spend more and more money and time in raising pets. With this trend, the market of business relates to pets in significantly growing due to pet owners' increasing consumption power for their pets. Consequently, there are always new pet accessories developed. Products for pets' foods, clothes, housing, transportation and even entertainment are quite diversified. Furthermore, modern pet accessories also reflect a trend of personification of pets. For example, there are clothes, pants, hats, shoes and other dressing for pets like those for the human being. Therein, pet shoes are effective in protecting pets from outdoor contaminants, bacilli or parasites. Besides, pet may often scratch their bodies with their paws and get hurt by the sharp claws. In this case, pet shoes are also effective in preventing such injuries. However, while the pet shoes are usually costly, they only function as clothing, and fail to provide any additional function to meet pet owners' needs.

Hence, this is a problem for the inventor to solve.

### SUMMARY OF THE INVENTION

The present invention provides a pet shoe that has a warning device so that when a pet wearing the pet shoe has its foot moving, a vibration switch in the warning device senses movement and accordingly drives a light-emitting element to emit light, thereby providing warning.

### BRIEF DESCRIPTION OF THE DRAWINGS

The invention as well as a preferred mode of use, further objectives and advantages thereof will be best understood by reference to the following detailed description of illustrative embodiments when acquire in conjunction with the accompanying drawings, wherein:

FIG. 1 is a perspective view of a pet shoe of the present invention;

FIG. 2 is an exploded view of the pet shoe of the present invention;

FIG. 3 is a schematic drawing showing a pet wearing the pet shoes of the present invention;

FIG. 4 is a perspective view of a pet shoe of the present invention according to another embodiment; and

FIG. 5 is a perspective view of a pet shoe of the present invention according to another embodiment.

### DETAILED DESCRIPTION OF THE INVENTION

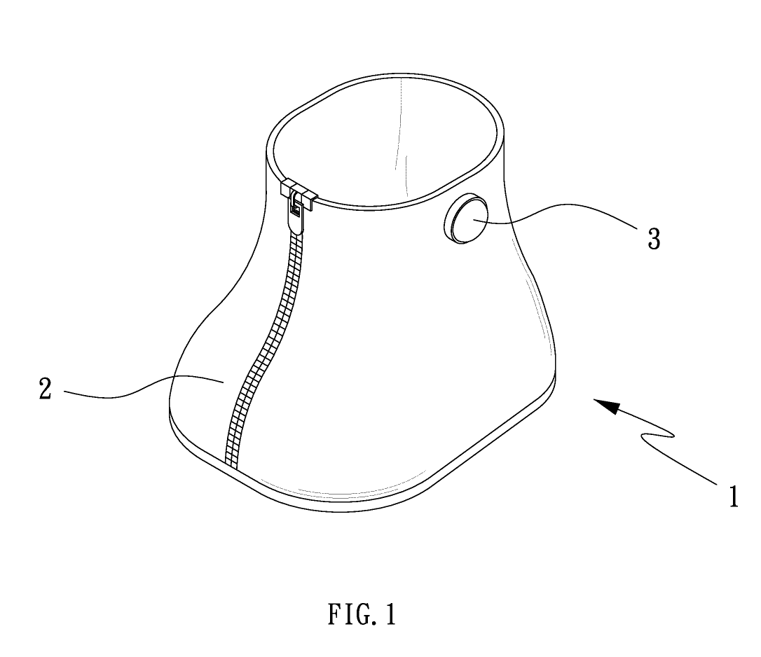

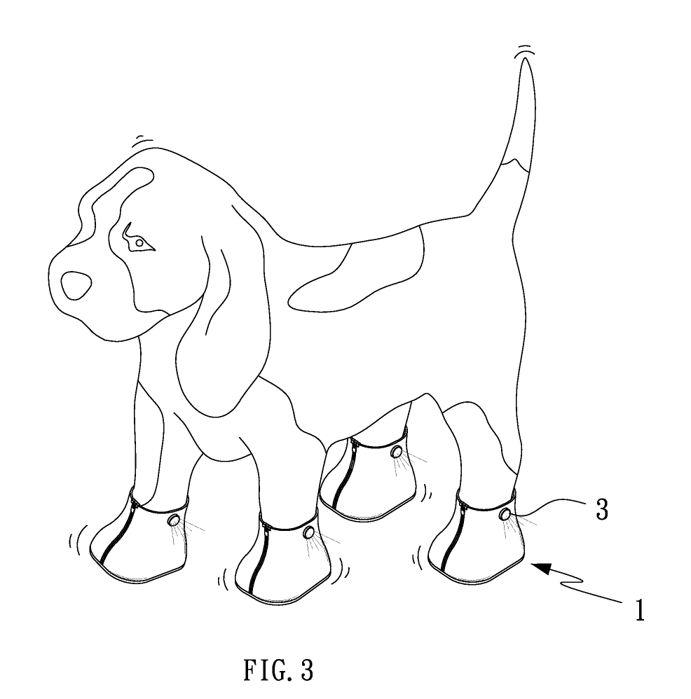

Please refer to FIGS. 1, 2 and 3 for a perspective view, an exploded view and an applied view of the present invention. As can been seen in the drawings, a pet shoe 1 primary comprises:

a shoe body 2; and

a warning device 3, which at least includes a base 31, a vibration switch 32 and at least one light-emitting element 33 that may be a light bulb, an LED or an OLED, wherein the vibration switch 32 is settled in the base 31 together with a control chip 34 and a power-supply element 35.

In use of the pet shoe 1, the shoe body 2 is to be put on a foot of a pet. When the pet moves, movements of its foot move the shoe body 2, so that the vibration switch 32 inside the base 31 senses the movements and in turn, via the control chip 34, drives the light-emitting element 33 outside the base 31 to emit light. With the light emitted by the light-emitting element 33, the pet can be easily found by its owner at night or in dark places. When the pet walks along streets, the light also helps a car driver to visually notice the presence of the pet, thereby preventing the pet from car accidents.

Therein, the way the light-emitting element 33 emits light may be preprogrammed by the control chip 34. When the vibration switch 32 sense the movements, the light-emitting element 33 may regularly blink or blinks with different frequencies that are determined by the extent of the movements sensed by the vibration switch 32. The light-emitting pattern of light-emitting element 33 is not to be limited herein.

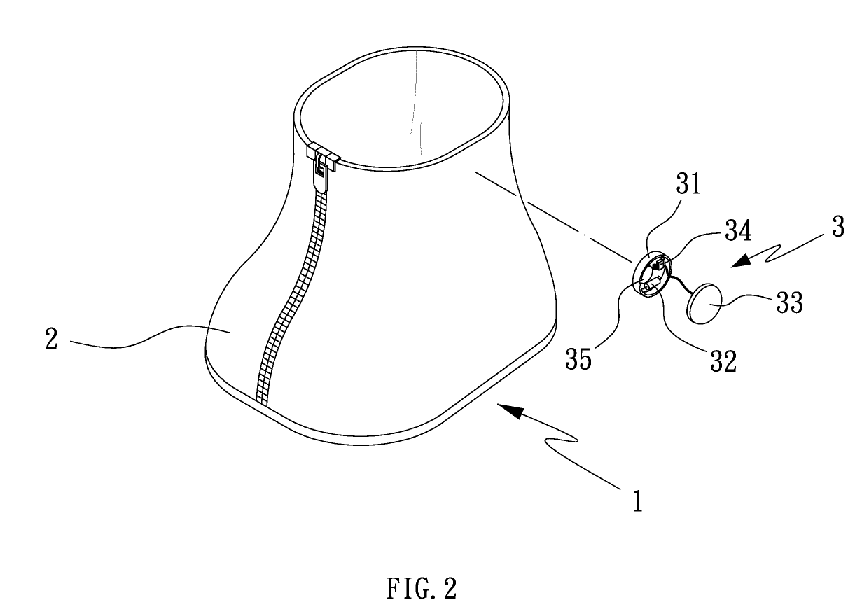

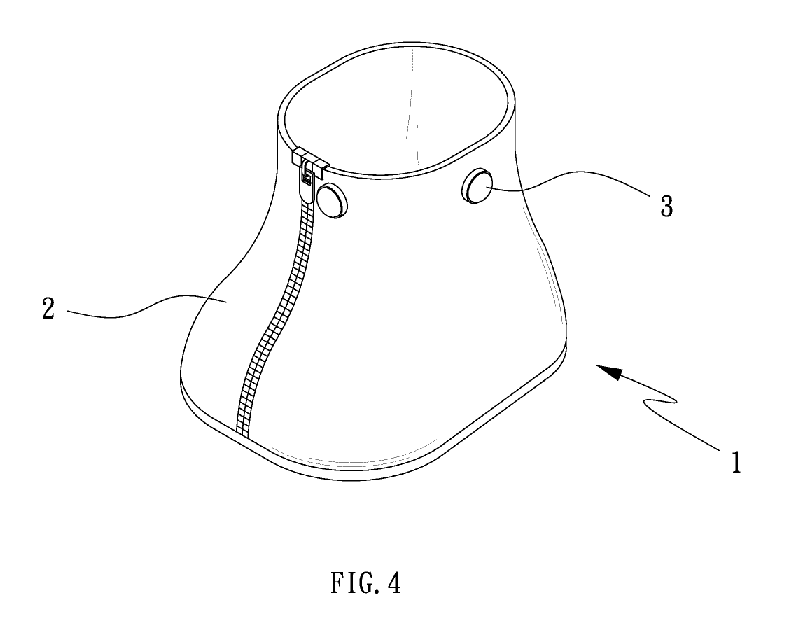

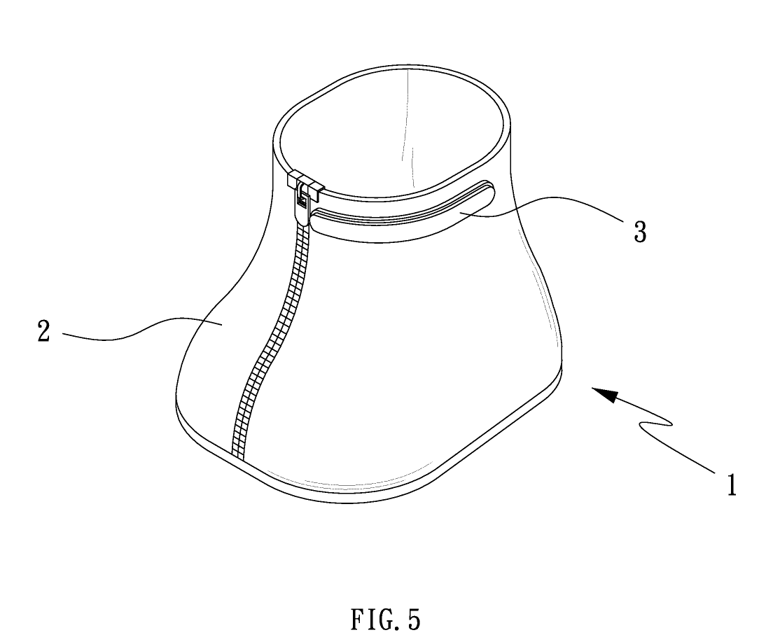

FIGS. 4 and 5 provide alternative embodiments of the present invention. As clearly indicted in the drawings, in addition to the single warning device 3 on the pet shoe 1 as shown in FIGS. 1 and 2, more said warning devices 3 may be provided at different locations on the shoe body 2. Alternatively, the warning device 3 may be in a bar shape located at an upper edge of the shoe body 2 or a lower edge of the shoe body 2. Therefore, the form of the warning device 3 is not limited while the location where it is settled is not limited, neither, as long as it is appropriately set on the shoe body 2 so that the light emitted by the warning device 3 can be easily seen.

What is claimed is:

1. A pet shoe, comprising:
a shoe body; and
at least one warning device fixed to the shoe body and including a base, a vibration switch and at least one light-emitting element;
wherein when the shoe body is worn by a pet, the vibration switch in the warning device senses movements of the pet and accordingly makes the light-emitting element to emit light for warning.

2. A pet shoe as claimed in claim 1, wherein the base further includes a power-supply element and a control chip.

3. A pet shoe as claimed in claim 1, wherein the light-emitting element is a light bulb, an LED or an OLED.
